(19) United States
(12) Patent Application Publication
(10) Pub. No.: US 2010/0162874 A1
(43) Pub. Date: Jul. 1, 2010

(54) MODULAR POST ASSEMBLY FOR FOOT-OPERATED PEDAL

(76) Inventor: Akito Takegawa, Chiba (JP)

Correspondence Address: BERENATO & WHITE, LLC, 6550 ROCK SPRING DRIVE, SUITE 240, BETHESDA, MD, 20817, US

(21) Appl. No.: 12/347,067

(22) Filed: Dec. 31, 2008

(51) Int. Cl. G10D 13/02

(52) U.S. Cl. 84/422.1

(57) ABSTRACT

A drum pedal assembly comprising a base member having a first mounting section and a second mounting section and a footboard pivotally mounted to the base member. A universal mounting post is interchangeably mounted to one of the first and second mounting sections such that the mounting post may be selectively positioned at the left-hand or right-hand position with respect to the footboard on the base member. With this invention, the mounting post is sized and shaped to interchangeably operate in either of the first or second mounting positions defined by said first and second mounting sections. Further, a dual beater drum pedal assembly is provided whereby first and second mounting posts are respectively mounted to a single mounting section. The first mounting post includes a first drive shaft rotatably mounted thereto and a first beater member affixed to the first drive shaft. A second mounting post is mounted to the second mounting section and likewise includes a second drive shaft and beater rotatably mounted thereto. In this dual beater drum pedal, the first and second mounting posts are substantially identical in shape so that the first and second mounting posts may be swapped one for the other without altering the operation or performance of the drum pedal assembly.

### BACKGROUND OF THE INVENTION

1. Field of the Invention

The present invention relates to a foot-operated pedal and particularly to a modular post assembly of a drum pedal, which may be constructed as a single pedal assembly or a dual pedal assembly.

2. Description of Related Art

FIGS. 1-2 show a prior art embodiment of a dual drum pedal. A dual drum pedal includes two drum head beaters 12 and 22, which are respectively operated by the right and left feet of a performer, for beating a single bass drum 5. Both beaters 12 and 22 are supported for swinging on the frame 11 of the first pedal 10. A rotary shaft 23 on which the second beater 22 is supported for rotation is provided on the frame 11 of the first pedal 10. The rotary shaft 13 for the first beater 12 is also provided on the frame 11. The rotary shaft 23 is connected with the operating shaft 28. The shaft 28 is rotatably operated by the second pedal 20 which is separate from the first pedal. A connecting rod 40 rotatably joins the shafts 23 and 28. The bass drum 5 includes a drum head 5a, a drum body 5b and a drum hoop 5c.

There is a first pedal plate 10A for the performer's right foot. The footboard 10A is pivotally supported to the first pedal frame 11. A drive member 14, such as a sprocket, etc. is installed on the first beater rotary shaft 13. A chain 15, a belt, or the like connects the first pedal plate 10A and the drive member 14. There is an installation member 16 for the first beater 12, a cam 17 for the first beater rotary shaft 13, and a return spring 18 provided on the cam 17.

The second beater rotary shaft 23 for the second beater 22 is also provided on the first pedal 10 and its frame 11. An installation member 24 installs the second beater 22 on the second beater rotary shaft 23. As shown in FIG. 2, there is a respective cam 25 for the second beater rotary shaft 23, and a spring 26 provided on the cam 25 is for restoring the second beater 22 to its original orientation. A bearing 27 between the shaft 23 for the second beater and the first shaft 13 provides linked integration of the first beater rotary shaft 13 and the second beater rotary shaft 23 in a manner permitting each of them to be freely rotatable in a mutually independent manner.

The second pedal 20 includes a second pedal plate 20A for the performer's left foot, a second pedal frame 21 on which the plate 20A is rotatably supported, a second operating shaft 28 which is rotatably operated by the second pedal plate 20A, and a drive member 29, such as a sprocket, etc. for rotating the operating shaft 28. A chain, belt, etc. 30 joins the second pedal plate 20A and the operating member 29.

The connecting rod 40 transmits the rotation of the second operating shaft 28, which is caused by operation of the footboard 20A of the second pedal 20, to the second beater rotary shaft 23 supported on the first pedal 10. The rod 40 is joined with the operating shaft 28 at one end and with the second beater rotary shaft 23 at the other end through the respective universal joints 45 and 46 at both ends of the rod 40, so that the first pedal 10 and the second pedal 20 may be freely arranged by a performer at any orientation with respect to each other, to be selected by the performer using the pedals.

The prior art described above fails to provide a variety of configurations whereby a modular post system provides versatility for the user. The prior art fails to provide a pedal assembly whereby a single pedal can be converted to a double pedal by purchasing additional parts without having to purchase an entire double pedal, or whereby a double pedal can be converted to a single pedal simply by removing appropriate parts, or whereby a right-handed pedal can be converted to a left-handed pedal (and vice versa) by reversing the parts.

### SUMMARY OF THE INVENTION

A drum pedal assembly, comprising a base member having a first mounting section and a second mounting section and a footboard pivotally mounted to the base member. A universal mounting post is interchangeably mounted to one of the first and second mounting sections such that the mounting post may be selectively positioned at the left-hand or right-hand position with respect to the footboard on the base member. A drive shaft is rotatably mounted to the mounting post, a drive member is affixed to the drive shaft, and a beater member is mounted to the drive shaft. A linkage, chain, belt or other suitable means are provided for drivingly interconnecting the footboard to the drive member so that movement of the footboard moves the drive member to rotate the drive shaft for pivoting the beater member toward and away from a drum head of a drum as the drive shaft is selectively rotated in opposite directions. With this invention, the mounting post is sized and shaped to interchangeably operate in either of the first or second mounting positions defined by said first and second mounting sections.

Further, a dual beater drum pedal assembly is provided, comprising a base member having a first mounting section and a second mounting section. A first mounting post mounted to the first mounting section. The first mounting post includes a first drive shaft rotatably mounted thereto and a first beater member affixed to the first drive shaft. A second mounting post is mounted to the second mounting section. The second mounting post likewise includes a second drive shaft rotatably mounted thereto and a second beater member affixed to the second drive shaft. First and second means in the form of a linkage, a chain, a belt or similar system is provided for drivingly interconnecting a first footboard to the first drive shaft for pivoting the first beater member toward and away from a drum head of a drum as the first drive shaft is selectively rotated in opposite directions and for interconnecting a second footboard to the second drive shaft for pivoting the second beater member toward and away from the drum head as the second drive shaft is selectively rotated in opposite directions. In this dual beater drum pedal, the first and second mounting posts are substantially identical in shape so that the first and second mounting posts may be swapped one for the other without altering the operation or performance of the drum pedal assembly.

### BRIEF DESCRIPTION OF THE DRAWINGS

FIG. 1 illustrates a top view of a dual drum pedal according to the prior art.

FIG. 2 illustrates a front view of the prior art dual drum pedal of FIG. 1.

FIG. 3 illustrates a first embodiment of the drum pedal according to the present invention with a single post member mounted to the right side of the base member.

FIG. 4 illustrates the first embodiment of the drum pedal according to the present invention with the single post member mounted to the left side of the base member.

FIG. 5 illustrates a partial top section of the base member 107 with the post 110 removed.

FIG. 6 illustrates a partial view of the post 110 removed from the base member 107.

FIG. 7 illustrates the post mounted to the first or right side mounting section of the base member.

FIG. 8 illustrates the mounting post mounted to the second or left side mounting section of the base member.

FIG. 9 illustrates a dual drum pedal comprising a beater assembly and a remote pedal assembly interconnected by a connecting rod where the remote pedal assembly is located to the right of the beater.

FIG. 10 illustrates a dual drum pedal comprising a beater assembly and a remote pedal assembly interconnected by a connecting rod where the remote pedal assembly is located to the left of the beater.

FIG. 11 illustrates a partial view of a dual beater assembly.

FIG. 12 illustrates a complete view of the dual beater assembly of FIG. 11 with a remote pedal assembly disposed to the left side of the dual beater assembly.

FIG. 13 illustrates a complete view of the dual beater assembly of FIG. 11 with a remote pedal assembly disposed to the right side of the dual beater assembly.

FIG. 14 illustrates a dual beater assembly utilizing two remote pedal assemblies disposed on opposite sides of the dual beaters.

### DETAILED DESCRIPTION OF THE PREFERRED EMBODIMENTS

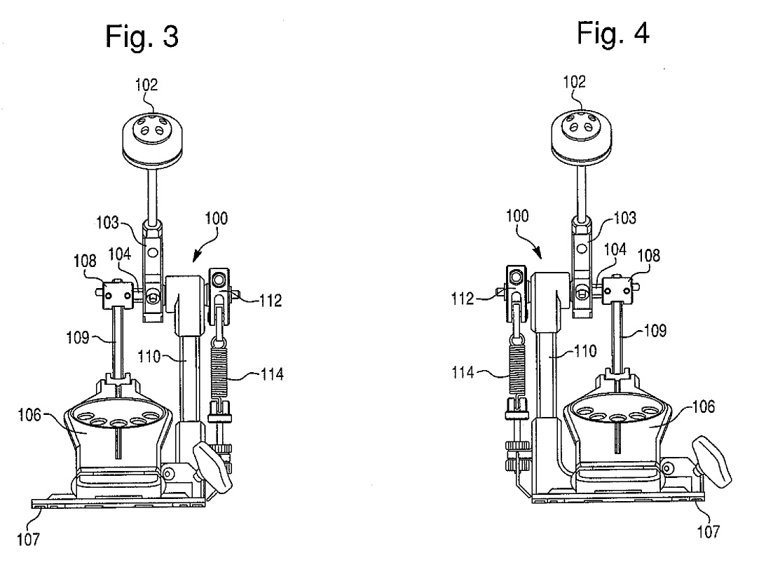

As shown generally in FIG. 3, a drum pedal 100 includes a beater 102 supported for rotation on the modular mounting post 110 of the pedal 100. The beater 102 is supported on the mounting post 110 through the rotary shaft 104. The shaft 104 is rotatably operated by the footboard 106 which is pivotally mounted on a floor plate of base member 107. A drive member 108, such as a sprocket, etc. is installed on the rotary shaft 104. A chain, a belt, or the like 109 connects the footboard 106 and the drive member 108. There is a drive member 103 for mounting the beater 102 onto the shaft 104. As is known in the art, a cam 112 and a return spring 114 bias the rotary shaft 104 and, thus, the beater 102 toward a position of least spring tension. In this manner the pedal or footboard is returned to the raised position.

In accordance with the present invention, the modular mounting post assembly 110 may be selectively positioned on either the right-side (FIG. 3) or left-side (FIG. 4) of the base member 107. Specifically, the post 110 may be disconnected from the right side of the base member 107 shown in FIG. 3 and repositioned on the left side of the base member 107 without the need for additional components or hardware.

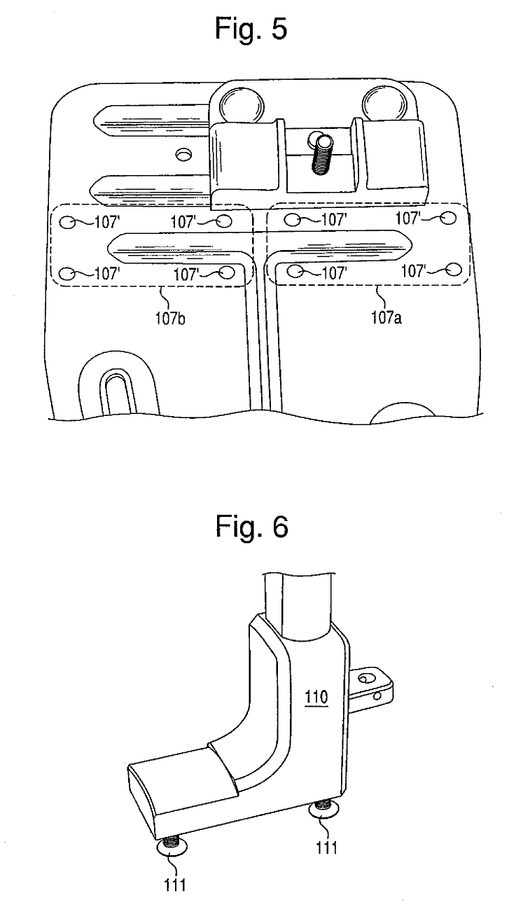

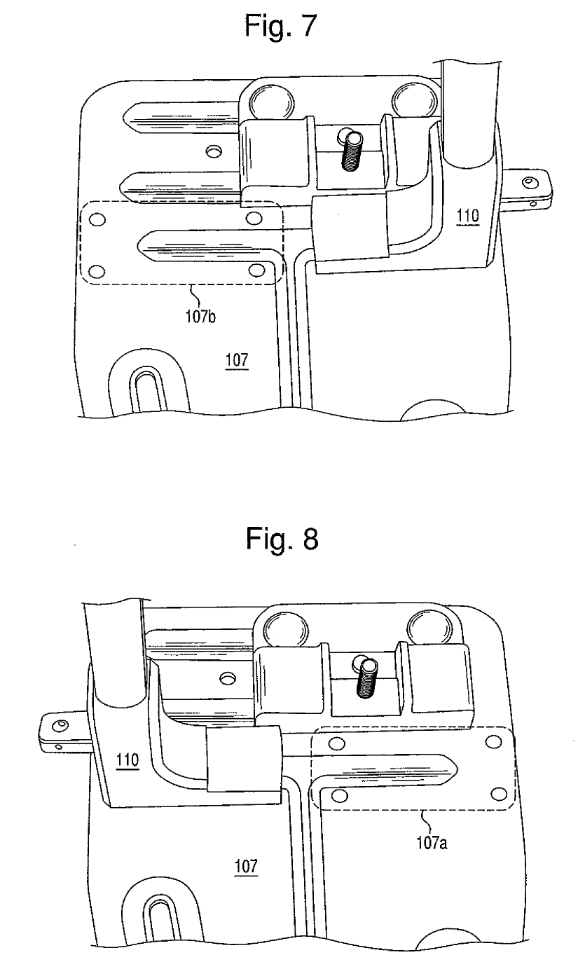

FIG. 5 illustrates a partial top section of the base member 107 with the post 110 removed. FIG. 6 illustrates a partial view of the post 110 removed from the base member 107. FIG. 5 is a partial top view of the floor plate or base member 107 illustrating a first or right mounting section 107a and a second or left mounting section 107b. Each mounting section 107a, 107b includes a plurality of bolt or screw holes 107′ through which the post 110 is secured to the base member 107. FIG. 6 is a partial perspective view of the modular post 110 showing the mounting base portion of the post 110 and associated screws 111 used to secure the post 110 to the base member 107. FIG. 7 shows the post 110 mounted to the first or right side mounting section 107a, and FIG. 8 shows the same mounting post 110 mounted to the second or left side mounting section 107b. It is to be understood that the modular post 110 can be rearranged without the need for additional components or hardware because the right side mounting arrangement and the left side mounting arrangement are mirror images of each other.

It should be understood that the chain/belt 109, footboard 106 and the drive member 108 are configured and arranged to work equally well in either of the right or left side positions of FIGS. 3 and 4.

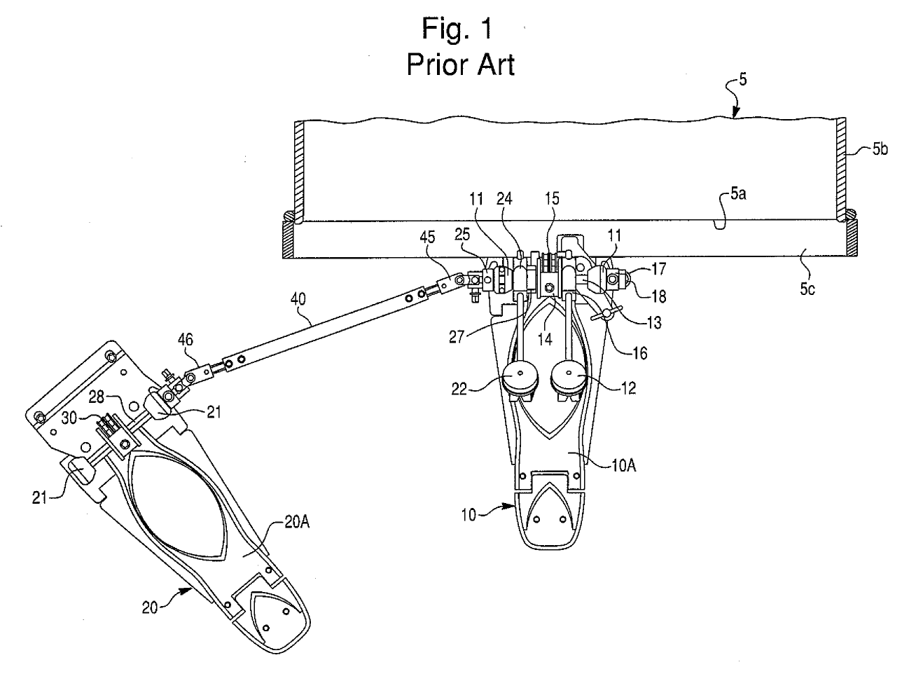

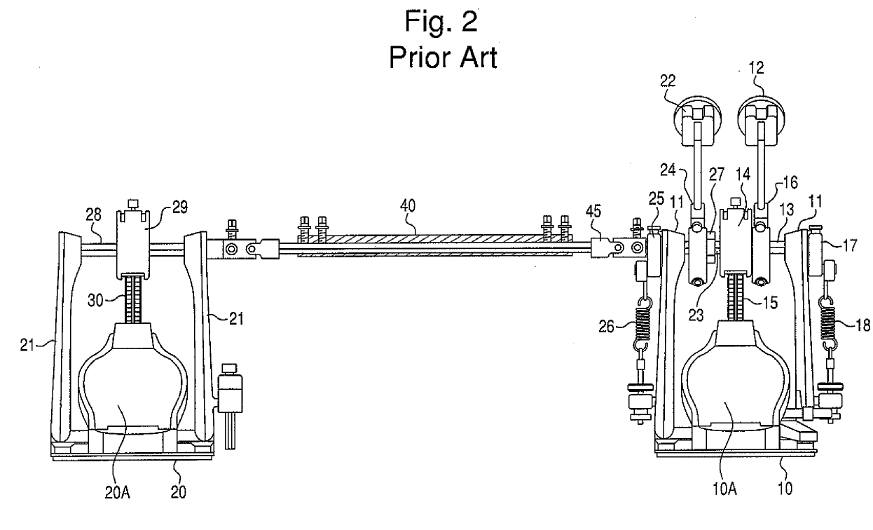

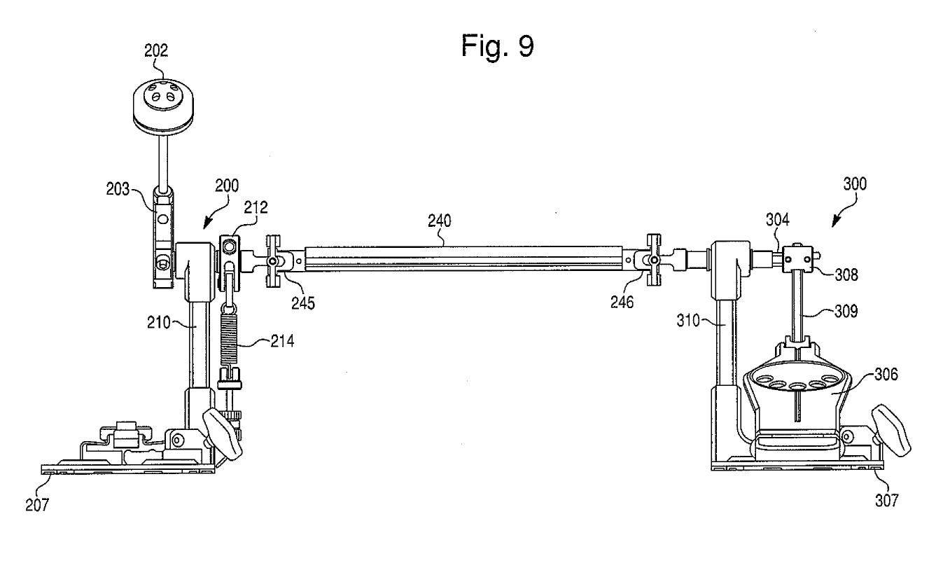

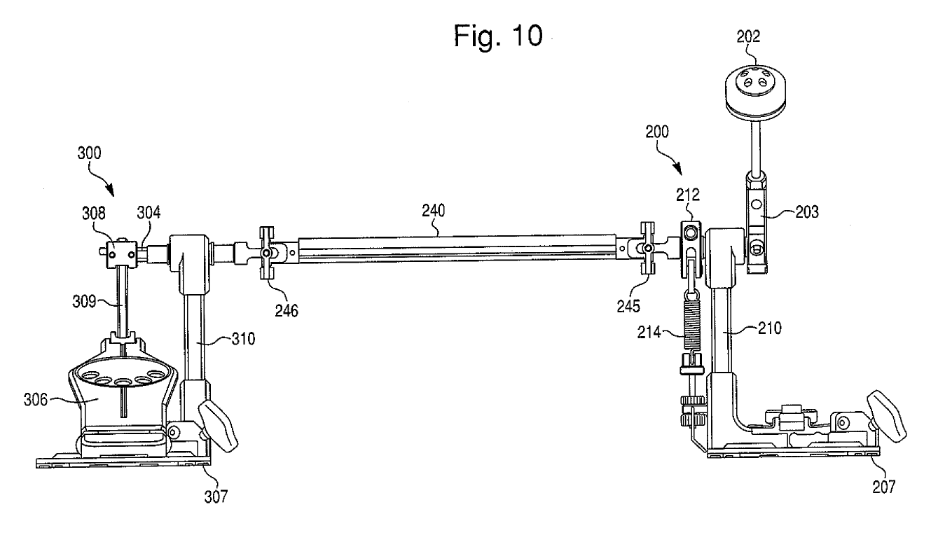

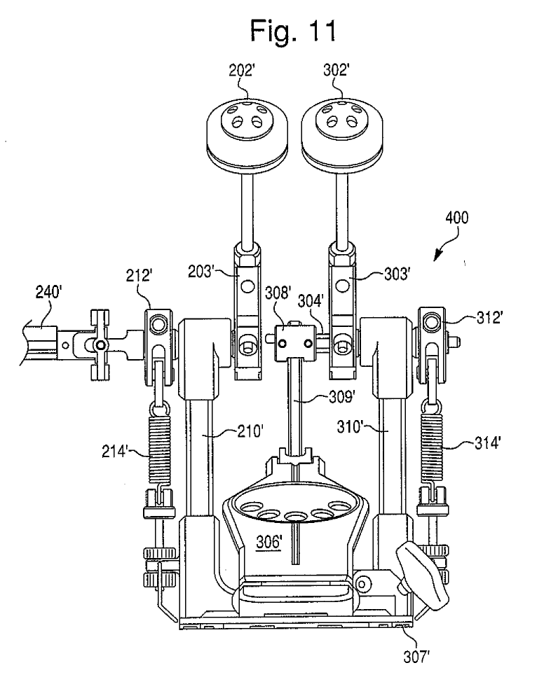

Additional embodiments and benefits of the present invention will now be described with reference to FIGS. 9-14 whereby the pedal assembly of FIGS. 3-8 are utilized in remote pedal assemblies (FIGS. 9 and 10) and in a dual beater and pedal assembly (FIGS. 11-14) similar to the type shown in prior art FIGS. 1 and 2.

FIG. 9 shows a dual drum pedal comprising a beater assembly 200 and a remote pedal assembly 300 interconnected by a connecting rod 240. The beater assembly 200 includes a beater 202 supported for rotation on the post 210. The post 210 is mounted to a base member 207 in the same manner described with reference to FIGS. 5-8. The beater 202 is supported on the post 210 through the rotary shaft (not shown). As with the embodiments of FIGS. 3-8, the shaft is rotatably mounted on the post 210 via suitable bearings. The embodiment of FIG. 9 however utilizes the remote pedal assembly 300 to drive the rotatable shaft. The remote pedal assembly 300 includes a base member 307 to which is pivotally mounted a footboard 306. A drive member 308, such as a sprocket, etc. is installed on a rotary shaft 304 rotatably disposed on the post 310. A chain, a belt, or the like 309 connects the footboard 306 and the drive member 308.

The connecting rod 240 is suitably connected to ends of the rotary shafts on the posts 210, 310 through universal joints 245, 246 in order to provide a flexible positioning arrangement for the beater assembly 200 and the remote pedal assembly 300 (see for example the angled arrangement shown in FIG. 1).

As is known in the art, a cam 212 and a return spring 214 bias the rotary shaft and, thus, the beater 202 toward a position of least spring tension. In this manner the pedal or footboard 306 also is returned to the raised position.

As shown in FIG. 9, the remote pedal assembly 300 is disposed on the right side of the beater assembly 200. In accordance with this invention, the position of the beater assembly 200 and remote pedal assembly 300 may be reversed as shown in FIG. 10. More specifically, the modular posts 210, 310 may be removed and reversed on their respective base members 207, 307. Then, the beater assembly 200and pedal assembly 300 may be reversed into the positions shown in FIG. 10 whereby the remote pedal assembly 300 is disposed on the left side of the pedal assembly 200.

FIG. 11 illustrates an additional embodiment of the present invention whereby the pedal assembly is reconfigured as a dual beater pedal assembly 400. In accordance with this invention, the dual beater pedal assembly 400 utilizes the modular components of the assembly shown in FIG. 10 to construct a single dual beater pedal assembly. Essentially, the modular post 210 of FIG. 10 is removed from its base member 207 and mounted onto the left mounting section of the base member 307 shown in FIG. 10. The dual beater pedal assembly 400 includes two drum head beaters 202′ and 302′, which are respectively operated by the right and left feet of a performer for beating a single bass drum (not shown). Both beaters 202′ and 302′ are supported for swinging on the base member 307′ through the modular mounting posts 210′, 310′. A first rotary shaft (not visible) is rotatably supported on the post 210′ and a second rotary shaft 304′ is rotatably supported on the post 310′, and the beaters 202′, 302′ are respectively mounted on these rotatable shafts. It is noted that the rotatable shafts are mounted to the posts 210′, 310′ in a cantilevered manner without additional support. Further, the two rotatable shafts are aligned along a common axis, but they are not interconnected such that a gap is provided between these two rotatable shafts.

There is provided a footboard 306′ typically for the performer's right foot. The footboard 306′ is pivotally supported to the base member 307′. A drive member 308′, such as a sprocket, etc. is installed on the rotary shaft 304′. A chain, a belt, or the like 309′ connects the footboard 306′ and the drive member 308′. There is an installation member 303′ for the beater 302′, a cam 312′ for the rotary shaft 304′, and a return spring 314′ provided on the cam 312′.

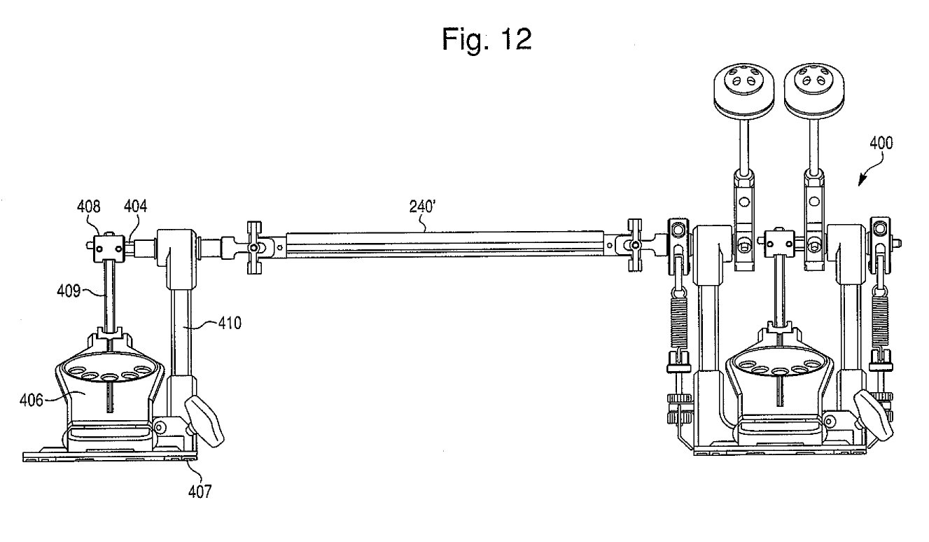

The rotary shaft for the beater 202′ is also provided on the base member 307′. This rotary shaft is connected with the connecting rod 240′. The shaft 404 is rotatably operated by the second pedal 406 (see FIG. 12) which is separate from the pedal assembly 400. The connecting rod 240′ rotatably joins the shaft on post 210′ and beater 202′ with the second pedal 406 (see FIG. 12). As shown in FIG. 11, there is a respective cam 212′ mount on the shaft rotatably mounted onto the post 210′. Additionally, the spring 214′ connected to the cam 212′ is for restoring the beater 202′ to its original orientation.

As shown in FIG. 12, there is provided a second footboard 406 for the performer's left foot. The footboard 406 is pivotally supported to the base member 407. A drive member 408, such as a sprocket, etc. is installed on the rotary shaft 404 which is rotatably cantilevered on the post 410. A chain, a belt, or the like 409 connects the footboard 406 and the drive member 408. As previously mentioned, the connection rod 240′ interconnects the remote pedal assembly so that the beater 202′ may be driven by the left pedal 406.

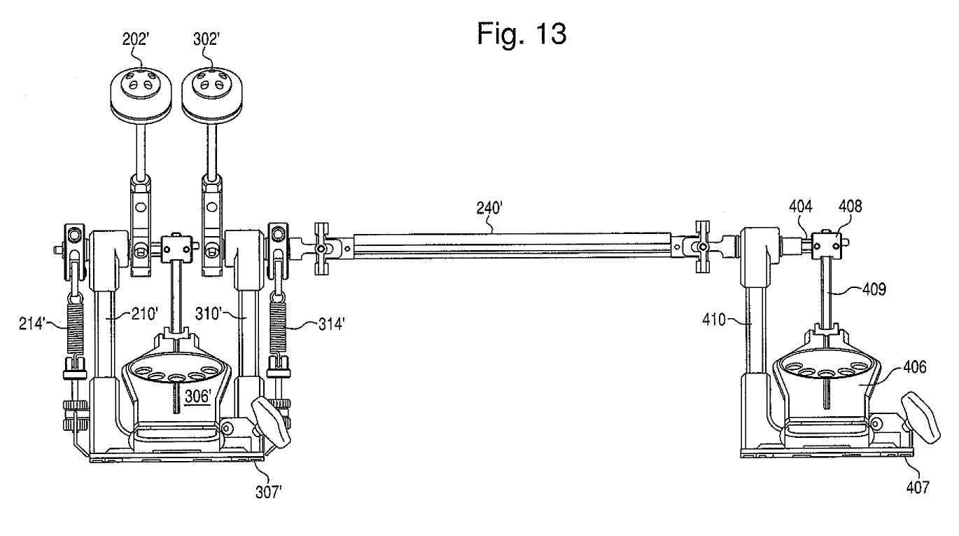

FIG. 13 illustrate an arrangement similar to the arrangement of FIG. 12 whereby the remote pedal assembly is disposed on the right side of the dual beater assembly. The arrangement of FIG. 13 exemplifies the unique benefit of this invention whereby the modular components of the invention may be reversed and rearranged to provide versatility without the need for additional components or hardware. To emphasize this point, the same reference numerals used for the arrangement of FIG. 12 are used to designate the components of FIG. 13. It is noted that the posts 210′, 310′, 410 are reversed from their positions in FIG. 12 and similarly mounted to their respective base members 307′, 407.

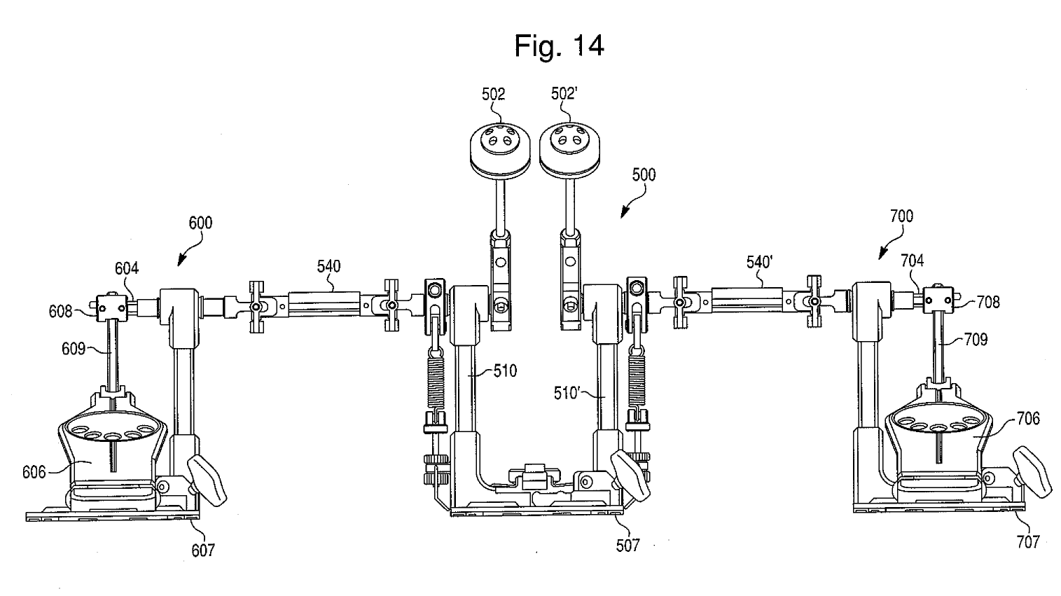

FIG. 14 illustrates a dual beater arrangement 500 with two remote pedal assemblies 600, 700 that drive two beaters 502, 502′ through connecting rods 540, 540′. In accordance with this alternate embodiment, the dual beater assembly 500 utilizes two modular posts 510, 510′ mounted onto the left and right mounting section of the base member 507. As shown, no pedal is mounted to the base member 507; instead, the pedal is removed and used for one of the left or rights pedal assemblies 600, 700. The dual beater pedal assembly 500 includes the two drum head beaters 502 and 502′, which are respectively operated by the right and left feet of a performer for beating a single bass drum (not shown). Both beaters 502 and 502′ are supported for swinging on the base member 507 trough the modular mounting posts 510, 510′. A first rotary shaft (not visible) is rotatably supported on the post 510 and a second rotary shaft (not visible) is rotatably supported on the post 510′, and the beaters 502, 502′ are respectively mounted on these rotatable shafts. It is again noted that the rotatable shafts are mounted to the posts 510, 510′ in a cantilevered manner without additional support. Further, the two rotatable shafts are aligned along a common axis, but they are not interconnected such that a gap is provided between these two rotatable shafts.

As shown in FIG. 14, the dual beater arrangement 500 is driven by two remote pedal assemblies 600, 700 through connecting rods 540, 540′. On the left side, there is provided a first footboard 606 typically for the performer's left foot. The footboard 606 is pivotally supported to the base member 607. A drive member 608, such as a sprocket, etc. is installed on the rotary shaft 604. A chain, a belt, or the like 609 connects the footboard 606 and the drive member 608. On the right side, there is provided a second footboard 706 typically for the perform's right foot. The footboard 706 is pivotally supported to the base member 707. A drive member 708, such as a sprocket, etc. is installed on the rotary shaft 704. A chain, a belt, or the like 709 connects the footboard 706 and the drive member 708.

From the foregoing description, it will be apparent to those of skill in the art that the invention provides a variety of configurations whereby a modular post system provides versatility for the user. The invention provides a pedal assembly whereby a single pedal can be converted to a double pedal by purchasing additional parts without having to purchase an entire double pedal, or whereby a double pedal can be converted to a single pedal simply by removing appropriate parts, or whereby a right-handed pedal can be converted to a left-handed pedal (and vice versa) by reversing the parts. Further, the rotatable shafts mount the beater to modular mounting posts in a cantilevered manner with the shafts aligned but spaced apart in the dual beater arrangement.

The foregoing detailed description of the preferred embodiments of the invention has been provided for the purpose of explaining the principles of the invention and its practical application, thereby enabling others skilled in the art to understand the invention for various embodiments and with various modifications as are suited to the particular use contemplated. This description is not intended to be exhaustive or to limit the invention to the precise embodiments disclosed. Modifications and equivalents will be apparent to practitioners skilled in this art and are encompassed within the spirit and scope of the appended claims.

1. A drum pedal assembly, comprising:
a base member having a first mounting section and a second mounting section;
a footboard pivotally mounted to said base member;
a mounting post interchangeably mounted to one of said first and second mounting sections;
a drive shaft rotatably mounted to said mounting post;
a drive member affixed to said drive shaft;
a beater member mounted to said drive shaft;
means for drivingly interconnecting said footboard to said drive member so that movement of the footboard moves the drive member to rotate the drive shaft for pivoting the beater member toward and away from a drum head of a drum as the drive shaft is selectively rotated in opposite directions;
wherein said mounting post is sized and shaped to interchangeably operate in first and second mounting positions defined by said first and second mounting sections.

2. The drum pedal according to claim 1, further comprising a second mounting post including a second drive shaft rotatably mounted to said second mounting post, wherein said first mounting post is mounted to said first mounting section and said second mounting post is mounted to said second mounting section.

3. The drum pedal according to claim 2, wherein said first and second drive shaft are aligned along a common rotation axis.

4. The drum pedal according to claim 3, wherein said first and second drive shaft have ends adjacent one another with a gap therebetween.

5. The drum pedal according to claim 2, wherein said first and second drive shaft rotate independently of one another.

6. The drum pedal according to claim 1, wherein said first drive shaft is mounted in a cantilevered position with respect to said first mounting post.

7. The drum pedal according to claim 1, wherein said first drive shaft is supported only at one end.

8. The drum pedal according to claim 2, further comprising a second beater member mounted to said second drive shaft.

9. The drum pedal according to claim 2, further comprising a second footpedal for driving said second drive shaft wherein said first and second drive shaft so that movement of the second footboard causes rotation of the second drive shaft for pivoting a second beater member toward and away from the drum head as the second drive shaft is selectively rotated in opposite directions.

10. A drum pedal assembly, comprising:
a base member having a first mounting section and a second mounting section;
a first mounting post mounted to said first mounting section, said first mounting post including a first drive shaft rotatably mounted thereto and a first beater member affixed to said first drive shaft;
first means for drivingly interconnecting a first footboard to said first drive shaft for pivoting the first beater member toward and away from a drum head of a drum as the first drive shaft is selectively rotated in opposite directions;
a second mounting post mounted to said second mounting section, said second mounting post including a second drive shaft rotatably mounted thereto and a second beater member affixed to said second drive shaft;
second means for drivingly interconnecting a second footboard to said second drive shaft for pivoting the second beater member toward and away from the drum head as the second drive shaft is selectively rotated in opposite directions,
wherein said first and second mounting posts are substantially identical in shape so that said first and second mounting posts may be swapped one for the other without altering the operation or performance of said drum pedal assembly.

11. The drum pedal according to claim 10, wherein said first and second drive shafts are aligned to rotate about a common axis of rotation.

12. The drum pedal according to claim 10, wherein a gap is disposed between said first and second drive shafts.

13. The drum pedal according to claim 10, wherein said first drive shaft is longer than said second drive shaft.

14. The drum pedal according to claim 10, wherein said first means comprises a first drive member and a first linkage connecting the first footboard to said first drive shaft through said first drive member.

15. The drum pedal according to claim 10, wherein said second means comprises a second drive member and a second linkage connecting the second footboard to said second drive shaft through said second drive member.

16. The drum pedal according to claim 10, further comprising a spring hooked to each of the first and second drive shafts such that spring tension returns the first and second drive shafts to a position of least spring tension.

17. The drum pedal according to claim 10, said first and second drive shafts are respectively mounted to said first and second mounting posts through respective bearing assemblies.
